(19) United States
(12) Patent Application Publication
(10) Pub. No.: US 2023/0002094 A1
(43) Pub. Date: Jan. 5, 2023

(54) CUTTING, CRIMPING AND STACKING MACHINE FOR CONICAL CORNET CONE PACKAGES

(71) Applicant: Mondi Kale Nobel Ambalaj Sanayi Ve Ticaret Anonim Sirketi, Kirklareli (TR)

(72) Inventors: Umit SAHIN, Kirklareli (TR); Osman KADIROGLU, Kirklareli (TR)

(21) Appl. No.: 17/771,731

(22) PCT Filed: Dec. 23, 2019
(86) PCT No.: PCT/TR2019/051184

§ 371 Date: Apr. 25, 2022

(30) Foreign Application Priority Data
Nov. 15, 2019 (TR) 2019/17817

(51) Int. Cl. B65B 35/50; B65B 61/06; B65B 5/02

(52) U.S. Cl. CPC B65B 35/50; B65B 61/06; B65B 5/02

(57) ABSTRACT

A cutting, crimping and stacking machine that is capable of performing automatically cutting, crimping and stacking conical cornet cone packages by itself.

### TECHNICAL FIELD

The invention relates to the production of conical cornet cone packages in which ice cream is placed.

The invention particularly relates to a machine which is capable of performing automatically the cutting, crimping and stacking processes of conical cornet cone packages by itself.

### THE STATE OF THE ART

Today, the cornet cone packages are used to present ice creams to consumers. As described in EP186479B1 publication numbered European Patent, the cornet cone packages are currently produced after the four different stage process. At the first stage, the plane package roller that is progressing like a carpet with its special blade structure is divided into special-shaped strips.

The roller divided into special-shaped strips comes out of the machine in two ways, namely reverse and straight ways. The strip, which comes out in reverse way at the second stage, is made ready for the cutting machine by being turned via a reversing machine. At the third stage, the prepared rollers are cut in one move and transferred to the crimping machine and then at the fourth stage, the pieced coming out of the cutting machine are crimped quickly and transformed into cornet cone package.

EP1864791B1 publication numbered European Patent relates to a method for the manufacturing of conical ice cream packages. By means of mentioned method, at the first cutting process, the upper band and lower band are obtained and following this process, the second cutting process is performed in order to obtain separate trapezoidal cuts, finally with the third cutting process carried out on the helical edge of the cut, thus a package showing conical expansion is formed by obtaining a circular edge having a single radius of curvature.

U.S. Pat. No. 2,194,275 (A) publication numbered patent also relates to a different method for the production of conical ice cream package.

TR2017/08349 numbered patent application also relates to a high speed cornet crimping machine having a high production capacity and a mechanic-independent motion control system, which comprises at least one feeding apparatus transferring the papers alternately to the conveying apparatus, the feeding apparatus engines providing drive motion to the feeding magazine, the conveying apparatus driving the papers coming from feeding magazine to the transfer line, the transfer line transferring the papers coming from the conveying apparatus to the tip crimping unite as standard and the tip crimping unites providing the tips of the product are crimped inwardly in a standard way. However, the related machine provides that the packing papers are only crimped and the cutting and stacking processes are performed manually by the operators. The cornet pieces to be crimped are stacked one on the top of the other and are going into the crimping machine quickly like a charger and then form the cornet package by being crimped. In other words, in the mentioned patent, the pieces to be made cone are stacked manually in a chamber and fed from there to the machine.

Consequently, the need for a machine that is capable of automatically cutting, crimping and stacking the conical cornet cone packages by itself and the inadequacy of the existing solutions necessitated an improvement in the related technical field.

### THE OBJECTS OF THE INVENTION

The main object of the invention is to develop a machine which is capable of automatically cutting, crimping and stacking the conical cornet cone packages by itself.

Another object of the invention is to increase production rate of the conical cornet cone packages by means of automatically performing the cutting, crimping and stacking processes.

Another object of the invention is to make the process completely continuous and automatic by eliminating the manual processes (stacking, etc.) during the production process of the conical cornet cone packages. It is to eliminate the additional labour force for manual operations (operator, etc.).

Another object of the invention is to stack the pieces to be made cone to chamber in the prior art and then feed them from there to the machine. The pieces to be made cone in the machine according to the invention are cut directly from the roller and transferred to the crimping machine. Therefore, by eliminating the feeding process between these two process, the production rate has been increased and the labour force has been decreased.

### BRIEF DESCRIPTION OF THE FIGURES

FIG. 1 is a perspective view of the cutting, crimping and stacking machine according to the invention.

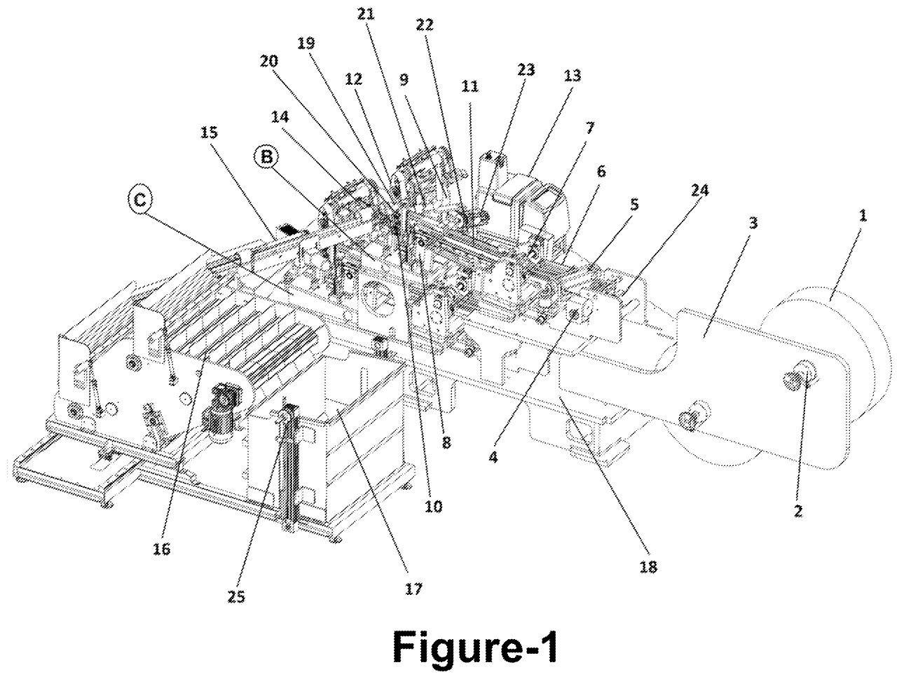

FIG. 2 is a detailed perspective view of the product cutting unite.

### REFERENCE NUMBERS

A. Cutting, crimping and stacking machine
B. First unite
C. Second unite
1. Semi-finished roller
2. Braking system
3. Tensioning (dancer) system
4. Product traction cylinder
5. Product cutting unite
   5.1. Rotating roller
6. Product transfer conveyor
7. half-moon reel
8. Paper transfer unite
9. Product crimper unite
10. Glue injector
11. Transfer rails
12. Moving sawdust blade system
13. Glue preparing tank
14. Product tip crimping unite
15. Crimped product counter conveyor
16. Output product transferring and collecting conveyor
17. Moving product collecting chamber
18. Frame
19. Upper crimper conical mold
20. Lower crimper conical mold
21. Sawdust suction pipe
22. On-off servo motor
23. Drive servo motor
24. Cutting positioning sensor
25. Product collecting chamber movement system

### DETAILED DESCRIPTION OF THE INVENTION

The invention relates to a cutting, crimping and stacking machine (A) that is capable of performing automatically cutting, crimping and stacking the conical cornet cone packages by itself. The cutting, crimping and stacking machine (A) according to the invention is comprised of two unites, namely a first unite (B) and a second unite (C), which have the same working principle, consist of the same elements and can operate independently of each other simultaneously. Provided that the working principle remains the same, the number of units can be increased and decreased depending on need and demand.

The loading process of semi-finished rollers (1) to the air shaft and electro-magnetic brake system (2) is performed separately by the operator. Then, by performing air locking, the semi-finished rollers (1) are secured in a rotatable way. The products coming out of the semi-finished roller (1) are passed through the tensioning (dancer) system (3) and compressed by hand between the product traction cylinders (4) in a pressed way. By measuring the tension between the dancer and the shaft with the electromagnetic brake system (2) and also the roller diameter with sensor, the brake is applied at variable moment value. As the machine rotates, the product, which is opened in proper and oriented way from semi-finished roller (1) automatically by the product traction cylinder (4), is passed through the product cutting unite (5) and cutting process is carried out into the desired dimensions.

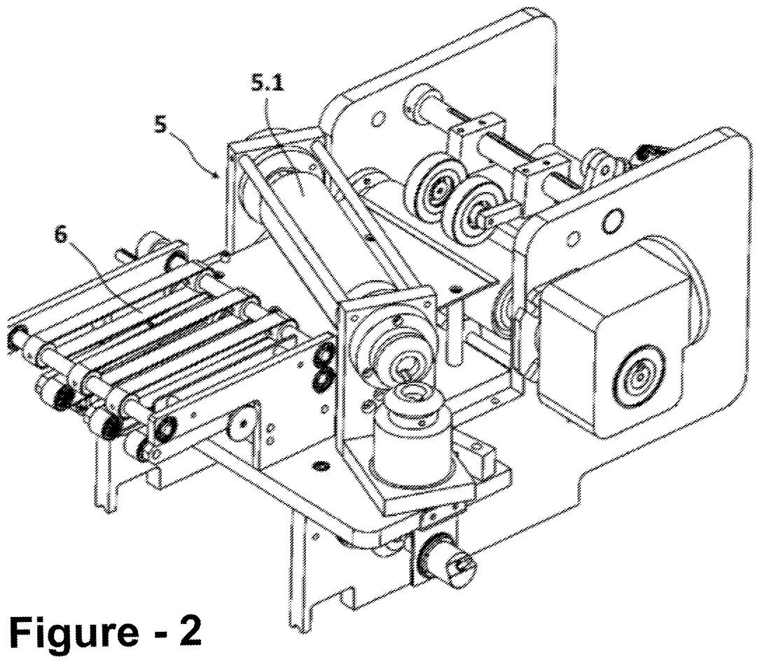

In FIG. 2, the detailed perspective view of the product cutting unite (5) has been given. As seen in the figure, the product cutting unite (5) comprises at least one rotating roller (5.1) in which the blade cutting the package strip is placed. The package strip coming from semi-finished roller (1) is separated into the suitable pieces for the production of cornet cone in one move. The blade on the rotating roller (5.1) cuts the package strip at each turn. The speed of the rotating roller (5.1) can be increased and decreased according to the type and dimension of the cornet cone to be cut.

Before the products enters into the product traction cylinder (4), the length of the products passed through the cutting positioning sensor (24) is measured and the traction amount is controlled and the cutting length is adjusted in this way. Then, the cornet papers, which are cut into desired size, are transferred to the crimping section by the product transfer conveyor (6). The accurate cutting process is achieved by synchronizing the accordance of the pattern and cut-off position on the paper and the position that the product traction cylinder (4) obtains with the servo motor from the cutting positioning sensor (24). The product cutting unite (5) operates by communicating with the product crimper unite (9) and the cut products are transferred to the paper transfer unite (8) by the half-moon reel (7) at the appropriate time while leaving out from the product transfer conveyor (8).

The position indicated as appropriate time information is the position of half-moon reel (7) on the product transfer conveyor (6) with respect to the product The products are transferred to the paper transfer unite (8) by the half-moon reel (7). The carrier feet situated on the paper transfer unite (8) start to transfer the products to the product crimper unit (9) by stacking the products in an equally spaced manner at a certain distance (until the product arrives at the crimper unite (9)). During this transferring process, the products are positioned relative to the upper crimper conical mold (19) and the lower crimper conical mold (20) by the transfer rails (11).

The products, which are positioned close to the product crimper unite (9) and in a certain range, are glued to the inner side of the products having the desired properties with the glue injector (10) just before entering the unite. The required glue is stored in a glue preparing tank (13). Then, the products that come in front of the product crimper unite (9) are vacuumed by the upper crimper conical mold (19) and the products taken over the paper transfer unite (8) are crimped between the two molds by the help of the lower crimper conical mold (20) and at the same time they are attached, so the crimping process is performed. During this crimping process, the upper crimper conical mold (19) and the lower crimper conical mold (20) turn around in the axis of the drive servo motor (23). During this crimping process, the excess sawdust arising from the opening part of the product is cut by the moving sawdust blade system (12) on the upper crimper conical mold (19). The cut sawdusts are suctioned by the sawdust suction unite (21) and discharged. After the crimping and sawdust cutting process are completed, the lower crimper conical mold (20) is opened by the on-off servo motor (22) and the products are thrown to the crimped product counter conveyor (15) by the upper crimper conical mold (19). In this way, crimped cornet packages are obtained and the production circle is continuously repeated.

Since the cutting, crimping and stacking machine (A) according to the invention contains a first untie (B) and a second unite (C), these processes are performed twice per unit time. These systems operate independently of each other. The products coming from the crimped product counter conveyor (15) are collected at the output product transferring and collecting conveyor (16). The products transferred by the output product transferring and collecting conveyor (16) are collected by stacking at desired amounts in the moving product collecting chamber (17). As the bottom of the moving product collecting chamber (17) is filled by the product collecting chamber movement system (25), it is lowered.

1. A cutting, crimping and stacking machine that is capable of performing automatically cutting, crimping and stacking the conical cornet cone packages by itself, the machine comprising:
at least one product cutting unit comprising at least one rotating roller, through which the product opened in an appropriate way from the automatically rotatable semi-finished roller is passed by the product traction cylinder to be cut into the desired dimensions and the blade cutting the package strip is placed;
at least one cutting positioning sensor which controls the traction amount by measuring the length of the products before entering into the product traction cylinder and adjusts the cutting length;
at least one paper transfer unit which allows the cut products to be transferred to the product crimper unit;
at least one glue injector gluing the products, which are positioned close to the product crimper unit and in a certain range, to the inner side of the products just before entering the unit;
at least one upper crimper conical mold vacuuming the glued products coming in front of the product crimper unit to take over the paper transfer unit;
at least one lower crimper conical mold performing the crimping process by means of compressing the vacuumed glued products with the upper crimper conical mold;
at least one on-off servo motor enabling the lower crimper conical mold to be opened after the crimping process and the sawdust cutting process are completed;
at least one crimped product counter conveyor, in which the products are thrown by the upper crimper conical mold after the lower crimper conical mold is opened;
at least one product transferring and collecting conveyor, in which the products coming from the crimped product counter conveyor are collected; and
at least one moving product collecting chamber, in which the products transferred from output product transferring and collecting conveyor are stacked.

2. The cutting, crimping and stacking machine according to claim 1, comprising at least one air shaft and electro-magnetic brake system, in which semi-finished rollers are loaded.

3. The cutting, crimping and stacking machine according to claim 1, comprising at least one tensioning (dancing) system, through which the products coming out of the semi-finished roller are passed before entering between the product traction cylinders.

4. The cutting, crimping and stacking machine according to claim 1, comprising at least one product transfer conveyor, which enables the cornet papers cut into desired size to be transferred toward the crimping section.

5. The cutting, crimping and stacking machine according to claim 1, comprising at least one half-moon reel, which enables the cut products to be transferred to the mentioned paper transfer unit at the appropriate time while leaving out from the product transfer conveyor.

6. The cutting, crimping and stacking machine according to claim 1, comprising at least one moving sawdust blade system, which cuts excess sawdusts arising from the opening part of the product during the crimping process and rotates over the upper crimper conical mold

7. The cutting, crimping and stacking machine according to claim 1, comprising at least one sawdust suction unit, which discharges the cut sawdusts by suctioning them.

8. The cutting, crimping and stacking machine according to claim 1, comprising at least one product collecting chamber movement system, which enables the bottom to be lowered as the moving product collecting chamber is filled by the products.
